(19) United States
(12) Patent Application Publication
(10) Pub. No.: US 2011/0022959 A1
(43) Pub. Date: Jan. 27, 2011

(54) Method and system for interactive engagement of a media file

(76) Inventor: Rob Troy, Sherman Oaks, CA (US)

Correspondence Address: Timothy J. Bechen;c/o Williams Mullen, Suite 1600, 200 South 10th St., Richmond, VA, 23218, US

(21) Appl. No.: 12/802,006

(22) Filed: May 27, 2010

Related U.S. Application Data
(60) Provisional application No. 61/182,199, filed on May 29, 2009.

(51) Int. Cl. G06F 3/048

(52) U.S. Cl. 715/720; 715/764; 715/719

(57) ABSTRACT

Generally, the present invention provides a method and system for interactive engagement of a media file having a default display. The method and system includes generating a visual landscape of the media file, the visual landscape including a visual display viewable by the default display of the media file and a plurality of peripheral displays of viewable areas outside of the default display. The method and system further includes activating an interactive display of the media file inside the visual landscape, the multi-view display including the ability to view the default display and the peripheral displays, as well as receiving a user input directing a point of view adjustment of the interactive display. And, the method and system includes generating an adjusted display of the interactive display based on the user input, the adjusted display presenting either: a portion of the visual display and a portion of the peripheral display; or a peripheral display.

### RELATED APPLICATIONS

The present application relates to and claims priority to Provisional Patent Application Ser. No. 61/182,199 having a filing date of May 29, 2009.

### COPYRIGHT NOTICE

A portion of the disclosure of this patent document contains material, which is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### BACKGROUND OF THE INVENTION

The present invention relates generally to electronic interactivity with a media file, and more specifically, user-directed interaction with a media file having a default display, allowing the user to generate and interact with a video display beyond the default media file display.

Advances in graphics and electronic processing have opened vast new realms of opportunities with visual media. For example, there have been significant improvements in computer-generated movies, as well as video games. Not only has advanced processing power increased the quality of generated content, but has also increased the quality of interactive content.

While visual features of movies provide a passive viewing environment, the other side of the technology is interactive technology, such as video games for instance. Even though there are improvements to the generated passive content, there fails to exist bridging interactivity with the passive content. Passive content may be the video game trailer advertising the game itself. The rich content of the interactive nature of a video game does not accurately translate to the passive environment of the trailer. Moreover, the data structure behind video game technology allows itself to be interactive, but the existing structure for game trailers does not envision or invite such techniques.

Currently, ad media for gaming is passive. The video commonly shows a first or third person perspective. The most common methods for creating this media are either using the basic in-game player camera(s) or utilizing debug camera tools. A third, less common approach is the creation of custom cameras through a secondary application. Often these latter cameras, unlike others mentioned previously, will follow preset paths, most likely referred to as splines, that are generated by the user in advance. Other cameras systems allow the user to adjust the camera on-the-fly.

Footage that was shot was considered “gameplay,” which refers in this instance to all types of scenes created in the game with the exception of pre-renders. Thus any scripted or non-scripted sequence happens within the game engine itself and is not simply a pre-encoded digital file that is being played back.

Various angles of a single scene may be shot, but ultimately only one angle of a scene will be shown to the viewer at a time, unless there is a picture-in-picture mode. In these rare instances, completely different angles of a scene will be shown. However these angles do not match up to meet one another to provide a single, continuous view of a single scene.

Upon completion of shooting footage for the game, it is then edited. Once the other various post-processes are complete, such as sound editing, color correction, editing to tape or digital storage, and encoding, the video is then presented to the viewer in various venues and formats. The viewing of these videos is passive, and the end-user cannot alter the experience by changing the perspective of what is seen.

The existing techniques of trailer generation fail to integrate and harness advantages of the interactive nature of video content outside of the existing passive content generation. Therefore, there exists a need for the interactive engagement of a media file to interact with traditionally passive content.

### SUMMARY OF THE INVENTION

Generally, the present invention provides a method and system for interactive engagement of a media file having a default display. The method and system includes generating a visual landscape of the media file, the visual landscape including a visual display viewable by the default display of the media file and a plurality of peripheral displays of viewable areas outside of the default display. The method and system further includes activating an interactive display of the media file inside the visual landscape, the multi-view display including the ability to view the default display and the peripheral displays, as well as receiving a user input directing a point of view adjustment of the interactive display. And, the method and system includes generating an adjusted display of the interactive display based on the user input, the adjusted display presenting either: a portion of the visual display and a portion of the peripheral display; or a peripheral display.

### BRIEF DESCRIPTION OF THE DRAWINGS

The invention is illustrated in the figures of the accompanying drawings which are meant to be exemplary and not limiting, in which like references are intended to refer to like or corresponding parts, and in which:

FIG. 1 illustrates a block diagram of one embodiment of a system for generating a media file;

FIG. 2 illustrates a block diagram of one embodiment of a system for interactive engagement of a media file;

FIG. 3 illustrates a flowchart of the steps of one embodiment of a computerized method for interactive engagement of a media file;

FIGS. 4 and 5 illustrate graphical representations of one embodiment of media environment data with a defined display and adjusted output displays;

FIG. 6 illustrates a flowchart of the steps of another embodiment of a method for the interactive engagement of a media file; and

FIGS. 7 and 8 illustrate graphical representations of additional embodiments of media environment data with a defined display and depth adjusted output displays.

### DETAILED DESCRIPTION

In the following description, reference is made to the accompanying drawings that form a part hereof, and in which is shown by way of illustration specific embodiments in which the invention may be practiced. It is to be understood that other embodiments may be utilized and design changes may be made without departing from the scope of the present invention.

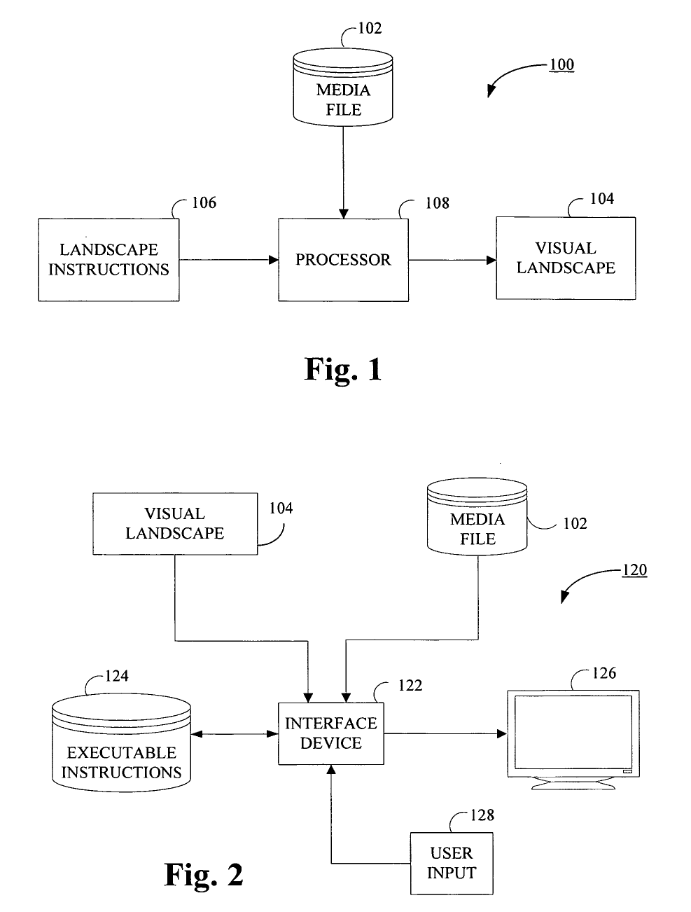

FIG. 1 illustrates one embodiment of a computerized system 100 that processes the media file 102 to generate a visual landscape 104. The system includes landscape instructions 106 for a processor 108. The processor 108, in response to the landscape instructions, uses the media file 102 as the input and thereby generates the landscape 104.

The media file 102 may be a defined static collection of images that represent an audio/visual display. For example, the media file 102 may be a video game trailer including an audio/video sequence of a portion of the video game. For example, a video game trailer may be a sequence of activity in the video game that is used to illustrate various details of the video game itself.

The visual landscape 104 is the visual environment within which the images of the media file are presented. For example, if the media file involves walking down a hallway, the landscape represents all the details of the hallway and other details not readily visible from the default display of the media file. The default display is the predetermined display of the media file, such as the person walking down the hall, where there are various peripheral displays not visible in the default display because the peripheral displays are outside of the viewable scope of the default display.

The landscape instructions 106, as used herein, are the processing instructions provided to the processor 108 for generating the landscape 104 from media file 102. As noted below, the instructions 106 may include instructions for numerous camera angle point of view displays at various locations in the media file, thereby generating the visual landscape within which the default display of the media file operates.

In one embodiment, the footage of the visual display is created by manipulating the software code of a default debug camera such that the camera has variable offset angles and can be set from the default zero degree (center point) front view. The creating of the footage for the landscape also includes creating the ability within the code to have a scene replay after the user has already scanned through the sequence of images.

The creating of the footage also includes determining the proper field of view for the camera and the camera's relationship to the angle of degrees adjustment from the default center point. There are important interrelationships between the field of view and camera angle offset from the camera center point. Typically, the higher the (wider) the field of view, the larger the difference is between camera angles. Thus a wider field of view typically equates to less camera angles. Once this relationship has been established, further adjustments may be made to the pitch and roll of the camera to compensate for optical distortion that may occur in first and third camera person angles typically found in gameplay.

One embodiment includes replaying the scene and adjusting the angle offset from the center point until all angles from within the scene have been shot and are thus visible and recordable. The replay of the scenes of the default display of the media file may be performed by a game engine tool including various possible embodiments. For example, a game engine tool, such as within the processor 108 of FIG. 1, may utilize memory to remember the placement of various variables within the scene and when the variables are called and implemented when the scene is played again. In another embodiment, the entire scene may be dumped into a frame buffer such that when it is replayed, it is essentially a movie so that during playback, the engine is playing back frames but not performing any actual manipulation, particle effects or other systems which would normally be used to create a scene for standard gameplay.

In one embodiment, the various shots of the display may include a slate marker or a playback counter so that each scene can be cued to the correct in-point for stitching. In one embodiment, all scenes may be shot with post effects, such as camera shake and/or shell-shock (e.g. double vision associated with semi-conscious player view). In one embodiment, footage is shot at no more than 40% of normal speed to allow for compensation of dropped frames, warping of angles, and variation in possible speed ramps if the scenes are the subject of trailer-type edit.

The creation of the footage also includes the assemblage of the various angles with a post-processing program. For example, post processing may be done with the After Effects® software application. The stitching may be performed using the markers or timing of the capture scenes. Stitching, as used herein, refers to the known practice in the post processing industry where two or more angles of a shot are combined together their seams are hidden by using any number of available artistic techniques.

Based on the post-processing assembling, stitching of the angles may be performed to clean-up any visually improper abutments between various angles, to thereby create a seamless transition between the angles. Once the stitching is complete, the entire scene may be scaled upwards, if necessary, to remove any playback markers. The post-processing operations may be included within the processor 108, or in another embodiment, may be performed on a separate processing device (not shown), wherein the separate processing device may be more specialized for post-processing operations.

The footage may thereupon be exported. One embodiment includes exportation of the footage in an uncompressed or highly lossless format. The footage of the visual landscape 104 may thereupon be recompressed. One embodiment includes using a set of compression specifications that allow for highly compressed, but high quality video, such as in an MPEG-4 format. In one embodiment, the compression may be performed by a highly skilled individual with expertise in compression technology or using compression technology to thereby create the smallest, yet highest quality file that maintains the integrity of the motion, color and effects within the scene with a minimal amount of artifacting.

The compressed file may then be inserted into a display application, such as for example a Flash® application, where the application allows user interaction to rotate the movie file around. For example, the movie may be akin to sitting on a carousel and the user is provided with full 360 degree rotation upon all three axis, as described in further detail below.

In another embodiment, the processor 108 may further include additional elements for display during playback of the media file, as described in further detail below. For example, the visual landscape may include visual graphics or other elements that become visible during the user interaction. For example, a graphical display of a company logo or additional information may be placed at a particular location in the visual landscape, whereas this element was not in the original media file 102. The additional information may either be static, such as a graphical image or may be interactive to the user during the display. The graphics may be inserted in an overlay manner and interactive components may be computationally coded therein.

The interactive components may be embedded graphical effects, such as Flash®-based graphic effects, in key areas in the visual landscape. These components may be added to the video via touch points so that when a cursor or pointing device engages these touch points, the graphics can become active. For example, if a user places a cursor over a particular item in display field, a graphic may be called up to display a description of the item. It is recognized that any number different types of uses may be envisioned, including not only informative to the user, but also promotional uses as recognizable to one skilled in the art . . . .

FIG. 2 illustrates a system 120 that provides user interaction with a media file 102 using the visual landscape 104. The system 120 includes the landscape data 104, media file 102, an interface device 122 and executable instructions 124 stored on a computer readable medium, as well as a display device 126 and user input device 128. The interface device 122 may be any suitable type of processing device, including one or more processing devices, operative to perform processing operations in response to the executable instructions 124. The display 126 may be any suitable type of display device operative to receive an output display signal from the interface device 122. The user input 128 may be any suitable type of input device, such as for example, but not limited to, a keyboard, mouse, game controller device or any other suitable device as recognized by one skilled in the art. It is further noted various aspects and details of the system 120 have been omitted for clarity purposes only, including for example communication interface and data exchange details, as well as additional processing environment details.

The system 120 allows a user to interact with the media file 102 based on the user interactions received from the user input device 128. The interface device 122 performs processing operations, in response to the executable instructions 124, to generate the output visible on the display 126. For example, if the media file is a video game trailer and the media file 102 is a 30 second sequence of video game activity, the user interface 122 performs processing operations, described in further detail below, to allow the user to thereby engage in interactivity with the media file, including adjusting the view to display video graphics not visible in the media file 102.

By way of example, if the media file 102 shows a sequence of a video game character walking down a hall, the media file 102 may show the end of the hall getting closer and the details on the walls passing by the character moves. But, using interactivity, the user may be able to rotate the view while the person is walking and see behind, back down the hall, look up at the ceiling, look at the floor, among other examples. This interactivity is made possible based on the interface device 122 having accessibility to the media file 102 as well as the visual landscape data 104.

FIG. 2 illustrates the user input 128 and the display device 126 in a direct connection to the interface device, but this is not a limiting description. Various embodiments are available including the user input 128 and display 126 being in communication with the interface device 122 across a networked connection, such as an Internet or other networked connection. In another embodiment, the system 120 may be embedded in a stand alone processing system, such as for example of a mobile computing device or a kiosk. The viewing of the output may be on any suitable type of device, such as a mobile phone, mobile gaming device, mobile media viewers, laptop computer computers, personal media viewers such as electronic book readers, or any other suitable device recognized by one having skill in the art. For display, the interface 122 includes viewer software which may be usable or integratable with other software platforms, such as software from existing social media applications and/or web locations, for example.

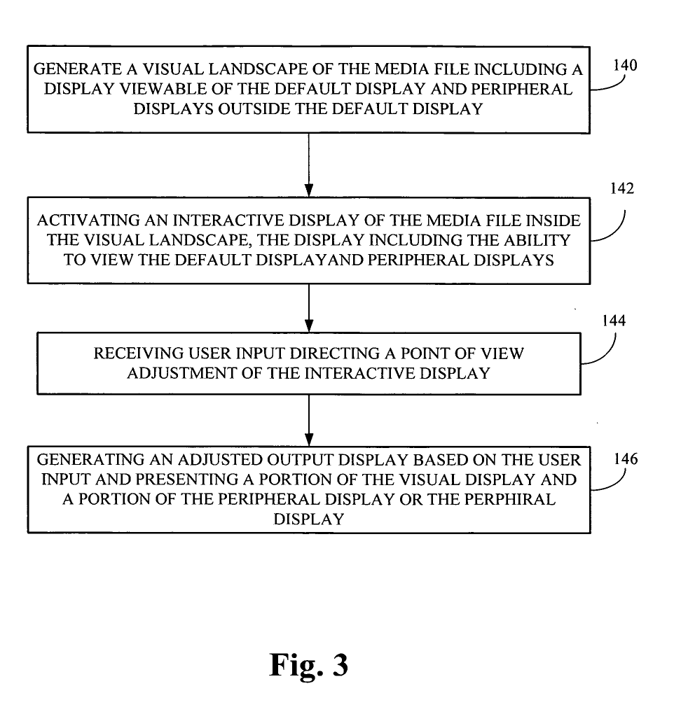

For brevity purposes only, the operations of the system 120 are described herein with respect to the flowchart of FIG. 3. FIG. 3 illustrates a flowchart of the steps of one embodiment of a method for user interactivity with a media file. In one embodiment, the method steps are performed, in response to the executable instructions 124, by the interface device 122.

In the method of FIG. 3, a first step, step 140, is to generate a visual landscape of the media file including a display viewable of the default display and peripheral displays outside the default display. This step may be performed using the processor 108 of FIG. 1, as discussed in greater detail above.

As used herein, the default display of the media file 102 is the sequence of images that provides the visual output. Using the above-noted example of walking down a hallway, the activity outside the viewable display area, the peripheral displays, may be images of the floor, ceiling or sidewalls not visible in the straight-ahead vantage point of the media file default display.

In the method of FIG. 3, a next step, step 142, is activating an interactive display of the media file inside the visual landscape, the display including the ability to view the default display and the peripheral displays. The activating of the interactive display may include, in one embodiment, displaying the default display of the media file until a user input is received, such as via the user input 128 of FIG. 2. As noted in FIG. 2, the interface device 122 may generate the visual display for display on the display device 126.

A next step in the method of FIG. 3, step 144, is receiving user input directing a point of view adjustment of the interactive display. With respect to FIG. 2, a user may enter the input command to the input device 128, which is received by the interface device 122. In response to the command, the interface is therefore operative to perform the next step of the method of FIG. 3, step 146, which is generating an adjusted output display of the visual display based on the user input.

Based on the user input, the visual display may be all of the default display, a portion of the default display and a portion of the peripheral display, or all peripheral display. For example, if the input command is to adjust the display to the left of the default display, the interface device 122 may thereby utilize the landscape data 104 to display details not previously visible. In the example of a person walking down a hall, the default display might show the end of the hall, but if the user adjusts the point of view display to look down, the display may change to viewing the peripheral display of the shoes of the individual walking down the hall, in a first-person display embodiment.

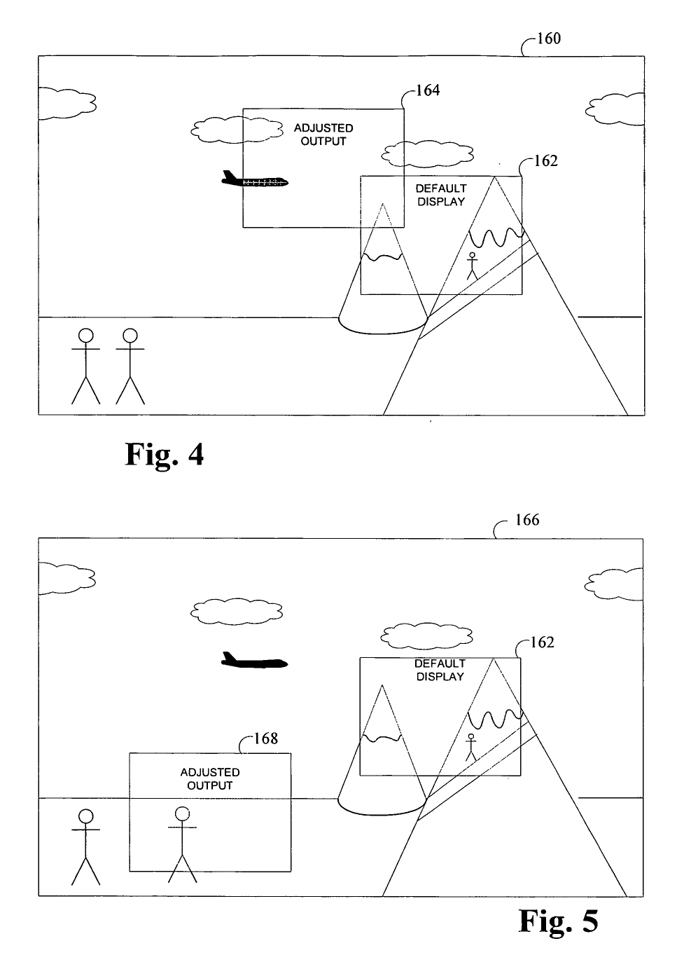

For further reference as to the visual landscape, default display and peripheral display, FIGS. 4 and 5 provide graphical illustrations of the described adjusted output display. FIGS. 4 and 5 illustrate sample graphical snapshots of a visual environment 160. This sample environment is a mountain scene and illustrates a 360-degree graphical environment representation, which in this embodiment represents the landscape 104 of FIGS. 1 and 2.

In the exemplary graphical illustrations, box 162 illustrates default display. This defined visual display represents a single time snapshot display that is generated by the processor 108 of FIG. 1 and the scene is a frame display in the media file 102. For example, if the media file was a trailer including scenes of a person walking on the side of a mountain, this exemplary snapshot would show that scene, but it is encased on the environmental data illustrated in the landscape 160. As described herein, the peripheral displays may be any of the displays outside of the box 162.

FIG. 4 illustrates one embodiment of an adjusted output display 164 that includes a portion of the defined visual display 162 and a portion of the peripheral display. In this example, the adjusted output display 164 may be generated in response to a user input requesting the point of view be adjusted to the left and upward. While the media file 102 would display the image of the person on the side of the mountain in the default display 162, based on the interactivity, the user is now able to see the top of the second mountain and an airplane flying overhead in the adjusted output display 164.

FIG. 5 illustrates another embodiment of a landscape 166 with an adjusted output display 168 that includes only a peripheral display. In this example, the adjusted output display may be generated in response to a user input requesting the point of view be adjusted further left and downward. While the media file 102 would display the image of the person on the side of the mountain in the default display 162, the user is now able to see an individual walking at the base of the mountain in the adjusted output 168, which is all peripheral to the default display 162.

Referring back to FIG. 3, the method is operative to be performed in conjunction with the ongoing display of the media file 102. The user interactivity can adjust the timing of the media file 102, for example pause, fast forward or rewind the media file, but absent instructions, the media file 102 may execute in its normal timing sequence. Again using the example of a first-person perspective of a graphical display of walking down a hallway, the user interaction and the generation of the adjusted display may be performed concurrent with the timing of the media file 102 display and the timing of the display of walking down the hall. For example, even if the adjusted display is rotated to view behind the person walking down the hall, the timing of the sequence of images in the media file 102 remains the same, i.e. the individual continues to walk down the hall, but now the visual output is the person looking behind instead of looking forward. In one embodiment, unless user instructions are contrary, the timing remains consistent with the default display and the user interface adjusts the output display.

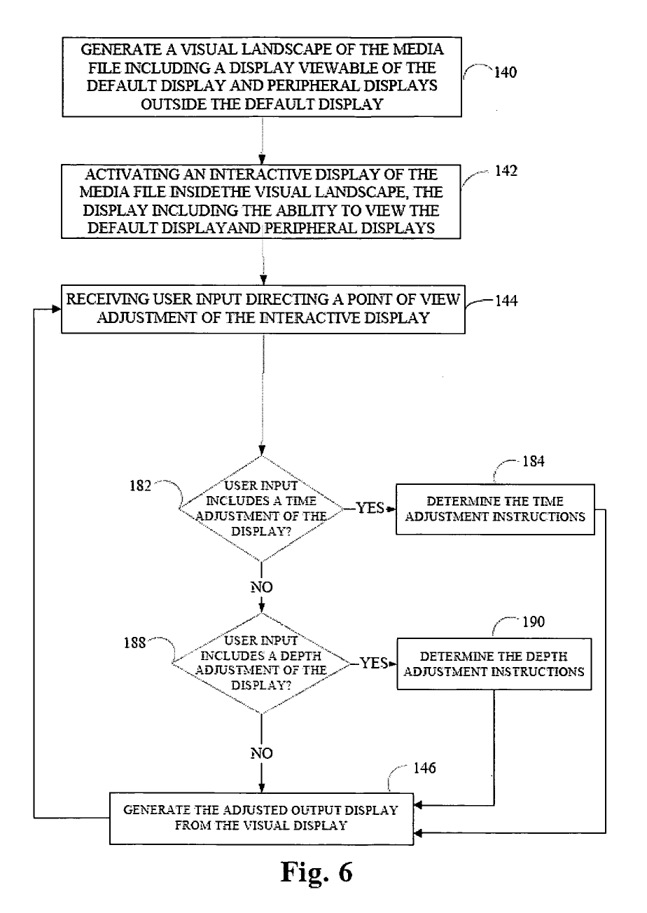

FIG. 6 illustrates a flowchart of another embodiment of a method for interactive engagement of a media file. The method includes steps similar to the method FIG. 3, but also includes additional steps as noted herein. The first three steps of this embodiment mirror steps 140, 142 and 144 of the method of FIG. 3.

In response to the user input, the method proceeds to step 182, which is a decision step to determine if the user input includes a time adjustment of the display. If in the affirmative, step 184 includes determining the time adjustment instructions, such as for example instructions to pause the display, rewind or fast forward the media file display. It is also recognized that the time adjustments may be even more granular adjustments of the time display, whether slower or faster in either the forward or reverse direction, such as for example tracking in reverse at half speed, quarter speed, eighth speed, etc.

Based on this time adjustment, the method continues to step 146, which is to generate the adjusted output display from the visual display, the adjusted output display presenting either a portion of the visual display and a portion of the peripheral display or just the peripheral display. This generated output display may be provided to a display device, thereby allowing for full user interaction between entering the user inputs and seeing the results on the display.

In one embodiment, the method reverts back to step 144 to receive additional user input commands. If the inquiry in step 182 is in the negative, a next step, step 188, is to determine if there is a depth adjustment. If yes, step 190 includes determining the depth adjustment, such as for example zooming in or out on an image. In response to the depth adjustment, the adjusted display can then be further modified, for example if the adjustment is to zoom in to a scene, the adjusted display then displays the zoomed feature with visible components becoming larger. Similarly, if the adjustment is to zoom out, the adjusted display reduces the scale of visible components and makes new components thus visible.

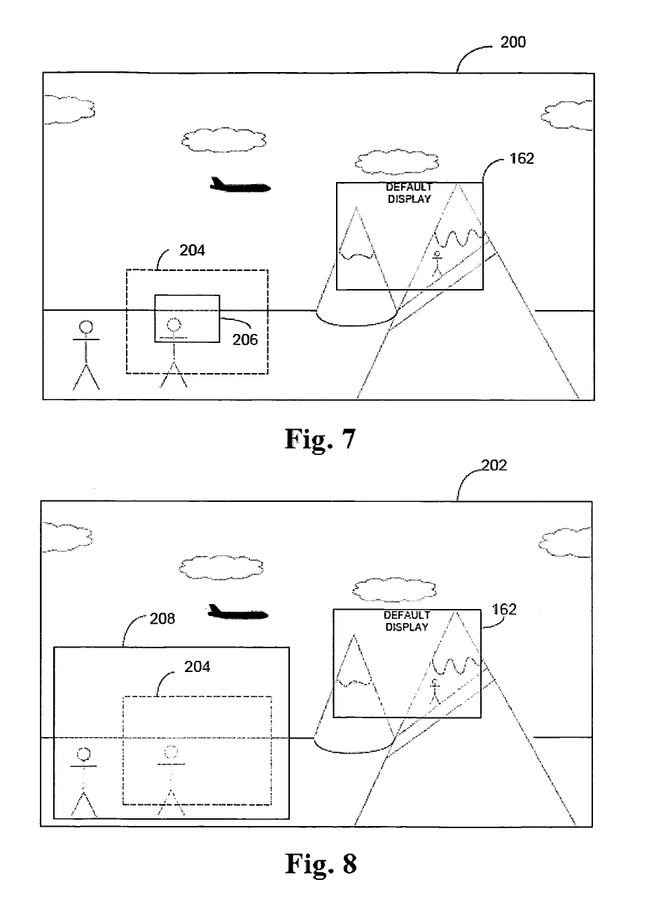

FIGS. 7 and 8 illustrate sample illustrations of the depth adjusted display using the same exemplary environment scene of FIGS. 4 and 5. These scenes 200 and 202 include the default display 162 and an original adjusted display 204. In FIG. 7, the depth adjusted display 206 is smaller, thereby indicating that the display has been zoomed inward. In FIG. 8, the depth adjusted display 208 is larger, thereby indicating the display has been zoomed outward.

With respect back to FIG. 6, the method continues to step 146, generating the adjusted output display. In this embodiment, the display of graphical details not previously visible may include details that were not visible due to the magnification details, such as elements becoming visible based on inward zooming or outward zooming. The depth adjustments are controllable by the user via the user input, thereby providing further interactivity with the media file.

Again, the method continues to revert back to step 144 for receipt of further user input 144. In this embodiment, the method iterates, playing the media file with the user interaction until the user terminates the interactive session or the media file completes the sequence of displays. Thereupon, the method of FIG. 6 allows for further user interactivity with the media file including time adjustment and depth adjustments, as well as the point of view adjustment. It is further noted that the steps 182 and 188 are not mutually exclusive such that a user may concurrently adjust the timing of the display and the depth of the output, whereas for simplicity, the flowchart of FIG. 6 illustrates these separately.

While various embodiments of the present invention have been described above, it should be understood that they have been presented by way of example, and not limitation. It would be apparent to one skilled in the relevant art(s) that various changes in form and detail could be made therein without departing from the spirit and scope of the invention. Thus, the present invention should not be limited by any of the above-described exemplary embodiments, but should be defined only in accordance with the following claims and their equivalents.

FIGS. 1 through 8 are conceptual illustrations allowing for an explanation of the present invention. It should be understood that various aspects of the embodiments of the present invention could be implemented in hardware, firmware, software, or combinations thereof. In such embodiments, the various components and/or steps would be implemented in hardware, firmware, and/or software to perform the functions of the present invention. That is, the same piece of hardware, firmware, or module of software could perform one or more of the illustrated blocks (e.g., components or steps).

In software implementations, computer software (e.g., programs or other instructions) and/or data is stored on a machine readable medium as part of a computer program product, and is loaded into a computer system or other device or machine via a removable storage drive, hard drive, or communications interface. Computer programs (also called computer control logic or computer readable program code) are stored in a main and/or secondary memory, and executed by one or more processors (controllers, or the like) to cause the one or more processors to perform the functions of the invention as described herein. In this document, the terms “machine readable medium,” “computer program medium” and “computer usable medium” are used to generally refer to media such as a random access memory (RAM); a read only memory (ROM); a removable storage unit (e.g., a magnetic or optical disc, flash memory device, or the like); a hard disk; electronic, electromagnetic, optical, acoustical, or other form of propagated signals (e.g., carrier waves, infrared signals, digital signals, etc.); or the like.

Notably, the figures and examples above are not meant to limit the scope of the present invention to a single embodiment, as other embodiments are possible by way of interchange of some or all of the described or illustrated elements. Moreover, where certain elements of the present invention can be partially or fully implemented using known components, only those portions of such known components that are necessary for an understanding of the present invention are described, and detailed descriptions of other portions of such known components are omitted so as not to obscure the invention. In the present specification, an embodiment showing a singular component should not necessarily be limited to other embodiments including a plurality of the same component, and vice-versa, unless explicitly stated otherwise herein. Moreover, Applicant does not intend for any term in the specification or claims to be ascribed an uncommon or special meaning unless explicitly set forth as such. Further, the present invention encompasses present and future known equivalents to the known components referred to herein by way of illustration.

The foregoing description of the specific embodiments so fully reveals the general nature of the invention that others can, by applying knowledge within the skill of the relevant art(s) (including the contents of the documents cited and incorporated by reference herein), readily modify and/or adapt for various applications such specific embodiments, without undue experimentation, without departing from the general concept of the present invention. Such adaptations and modifications are therefore intended to be within the meaning and range of equivalents of the disclosed embodiments, based on the teaching and guidance presented herein.

What is claimed is:

1. A method for interactive engagement of a media file having a default display, the method comprising:
generating a visual landscape of the media file, the visual landscape including a visual display viewable by the default display of the media file and a plurality of peripheral displays of viewable areas outside of the default display;
activating an interactive display of the media file inside the visual landscape, the multi-view display including the ability to view the default display and the peripheral displays;
receiving a user input directing a point of view adjustment of the interactive display; and
generating an adjusted display of the interactive display based on the user input, the adjusted display presenting either: a portion of the visual display and a portion of the peripheral display; or a peripheral display.

2. The method of claim 1, wherein generating the visual landscape further comprises:
manipulating a default debug camera such that the camera has variable offset angles;
replaying the media file using a plurality of offset angles to generate a plurality of image landscape components; and
assembling the components to generating the visual landscape.

3. The method of claim 2 further comprising:
creating a seamless transition between image components by adjusting the transitions therebetween.

4. The method of claim 2, wherein the generation of the visual landscape is performed using a post processing device.

5. The method of claim 1 further comprising:
exporting the visual landscape to an external processing device for performance on the activating of the interactive display on the external processing device.

6. The method of claim 5, wherein the visual landscape is exported in an uncompressed or highly lossless format.

7. The method of claim 1, wherein the user input further includes a time-adjustment of the adjusted display, the time-adjustment of the display sequence includes one or more of pause, fast forward and rewind.

8. The method of claim 1, wherein the user input further inputs a display depth adjustment of the adjusted output display,

9. The method of claim 1 further comprising:
embedding at least one interactive graphic object associated with the interactive multi-view display of the media file.

10. The method of claim 1, wherein the media file is a video game trailer.

11. A system for interactive engagement of a media file having a default display, the system comprising:
computer readable medium having executable instructions stored thereon; and
a processing device, in response to the executable instructions, operative to:
generate a visual landscape of the media file, the visual landscape including a visual display viewable by the default display of the media file and a plurality of peripheral displays of viewable areas outside of the default display;
activate an interactive display of the media file inside the visual landscape, the interactive display including the ability to view the default display and the peripheral displays;
receive a user input directing a point of view adjustment of the interactive display; and
generate an adjusted display of the interactive display based on the user input, the adjusted display presenting either: a portion of the visual display and a portion of the peripheral display; or a peripheral display.

12. The system of claim 11, the processing device, in response to further executable instructions, further operative to:
manipulate a default debug camera such that the camera has variable offset angles;
replay the media file using a plurality of offset angles to generate a plurality of image landscape components; and
assemble the components to generating the visual landscape.

13. The system of claim 12, the processing device, in response to further executable instructions, further operative to:
create a seamless transition between image components by adjusting the transitions therebetween.

14. The system of claim 12 further comprising:
a post processing device operative to generate the visual landscape.

15. The system of claim 11, the processing device, in response to further executable instructions, further operative to:
export the visual landscape to an external processing device for performance on the activating of the interactive display on the external processing device.

16. The system of claim 15, wherein the visual landscape is exported in an uncompressed or highly lossless format.

17. The system of claim 11, wherein the user input further includes a time-adjustment of the adjusted display, the time-adjustment of the display sequence includes one or more of pause, fast forward and rewind.

18. The system of claim 11, wherein the user input further inputs a display depth adjustment of the adjusted output display.

19. The system of claim 11, the processing device, in response to further executable instructions, further operative to:
embed at least one interactive graphic object associated with the interactive multi-view display of the media file.

20. The system of claim 11, wherein the media file is a video game trailer.
